(19) United States
(12) Patent Application Publication
(10) Pub. No.: US 2026/0279121 A1
(43) Pub. Date: Sep. 17, 2026

(54) Facility Access Control System with Carried Tokens and Facility Sensors

(71) Applicant: Leslie Mark Kolpan Carter, Boca Raton, FL (US)

(72) Inventor: Leslie Mark Kolpan Carter, Boca Raton, FL (US)

(21) Appl. No.: 19/678,596

(22) Filed: May 15, 2026

Related U.S. Application Data
(63) Continuation-in-part of application No. 18/897,096, filed on Sep. 26, 2024.
Application No. 18/897,096 is a continuation of application No. 17/938,864, filed on Oct. 7, 2022, now Pat. No. 12,131,600.

(51) Int. Cl. G07C 9/00

(52) U.S. Cl. CPC G07C 9/00563

(57) ABSTRACT

A security system for non-public, normally-open facilities such as schools. Persons authorized to be in the facility carry tokens with stored bio-data. Cameras and readers in the facility passively scan locations and current bio-data of persons and locations and stored bio-data of tokens within the facility. If a mismatch is detected of locations or bio-data, the system actuates facility closure and/or dispatches physical security.

### CROSS REFERENCE TO RELATED APPLICATIONS

The present application is a continuation-in-part of U.S. application Ser. No. 18/897,096, filed Sep. 26, 2024, which is a continuation of U.S. application Ser. No. 17/938,864, filed Oct. 7, 2022, the disclosures of which are incorporated herein by reference.

### TECHNICAL FIELD

The invention relates to security systems for non-public spaces such as schools or workplaces with a known population such as students or employees that require frequent access. The invention also relates to a wearable bio-data device used as a security token.

### BACKGROUND

In recent years, large non-public spaces such as schools and workplaces have all too often been the scene of mass shootings. Typically, but not always, the shooter is a member of the population he intends to harm. Several strategies have been employed to combat this social problem and increase facility security.

In some cases, armed guards and human intelligence have been deployed in an effort to reduce risk without substantially impacting the daily routine of students and employees. This system aims to reduce risk by identifying potential bad actors with human intelligence and stopping them with deadly force if necessary. While it attempts to be non-invasive on the student/worker population, guards carrying guns makes many people uncomfortable and particularly in the case of students may have a lasting negative impact on their psyche. The fact that shootings have continued over the past years suggests that these security measures have had little or no impact.

Passive security systems are also known. In these systems a security card or token of some type is remotely scanned to provide access to the token to provide access into and track members of the population throughout the facility. While such passive systems are noninvasive, they really only provide facility access to the token not the person. In other words, they can't determine if the token is stolen or borrowed. In addition to not being able to determine the identity of the person carrying the token, they also have no way to determine their mental or physical state in order to assess risk of providing access into and throughout the facility.

Another strategy to combat mass shooting risk at non-public spaces is simply to lock them down. In other words, each time a member of the known population attempts to enter they must identify themselves and subject themselves to an invasive search. Identification can be accomplished by known security cards but a higher level of security which protects against security card theft is a bio-data scan of some type. Known bio-data scans include fingerprint and iris scans, DNA sequencing, tooth matching, weighted trained AI, voice detection, biological barcoding, and implanted chips, to name a few. Metal detectors and body scans are examples of invasive searches that may be used instead of or in addition to bio-data scans.

An obvious problem with locking down facilities is that they become a type of prison. And although the risk of a mass shooting may be reduced, the psychological impact on workers and students can be immense. It's an unfortunate fact that elementary schools have become the scene of mass shootings and locking them down in this manner will almost certainly have a negative impact on student mental health and ultimately on our society as a whole.

What is desired therefore is a system limiting access to facilities such as schools and workplaces which increases student and employee security while minimizing psychological impacts of a locked down facility and/or a deadly-force-carrying security presence.

### SUMMARY

Accordingly, it is an object of the invention to provide improved security at normally-open nonpublic facilities such as schools and workplaces.

It is another object of the invention to provide a security system which limits access of nonpublic facilities to a known population.

It is a further object of the invention to provide a security system which is passive and does not require facility lockdown.

It is yet another object of the invention to provide a security system which limits access to a nonpublic facility based on a bio-data token.

It is yet a further object of the invention to provide a security system which alerts facility security if a member of the known accessing population is under physical stress consistent with a mass shooter.

Still another object of the invention is to improve security at schools in a way that limits psychological impact on students.

The invention achieves these and other objects by providing non-public, normally-open facilities such as schools with a security perimeter. The security perimeter passively scans persons attempting access and actuates facility closure if a security threat is detected. Security threats include: a person without any security token, a person with a security token that does not match their current bio-data, and a person who although they have a security token matching their current bio-data exhibits one or more physiological traits consistent with mental or physical distress, as measured by the token or otherwise. Members of the public needing access to the facility, such as parents in case the facility is a school, can obtain a temporary token at the security perimeter. Students or employees in case the facility is a workplace or school are issued or matched to a security token. The token may be a phone or watch or button which can: facilitate storage of a bio-data at the time the token is issued by the facility, facilitate measurement of the current value of the same type of bio-data from the wearing person in the population permitted facility access, and transmit the stored and current bio-data (or some indication that they match) to a passive reader at the security perimeter.

Preferably also, the token can sense physiological indicators consistent with a mass shooter such as elevated blood pressure, elevated pulse, some chemical imbalance of an alarming nature, or other indicators such as emotional state or movement patterns. In the invention, a sensed indication of physical or mental distress can be used to either close the facility or can simply be used to alert facility security to make a personal intervention with the population member in distress. In this way students can continue to enjoy an open school without daily invasive security requirements that can have negative psychological impacts while also being safer from the horror of mass shootings.

### BRIEF DESCRIPTION OF THE DRAWINGS

FIG. 1 is a schematic diagram illustrating a bio-data token based passive security system for a non-public facility such as a school in accordance with the invention.

### DETAILED DESCRIPTION

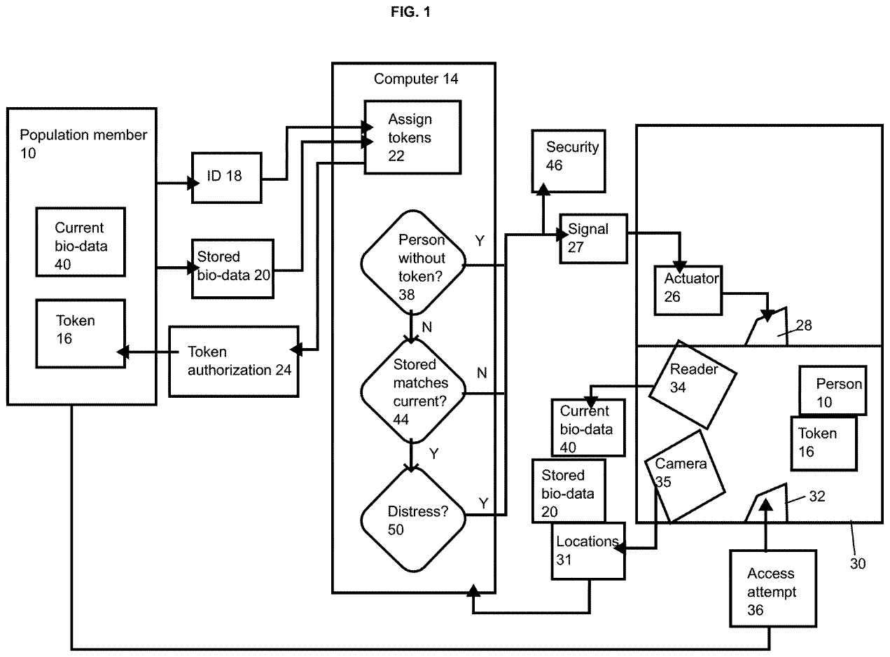

FIG. 1 depicts a security system of the invention which improves safe access of population members 10 to facility 12. Facility 12 is intended to be a normally-open but non-public facility such as a factory or school where a population, for example of known workers/students, access the facility on a regular basis. In facilities of this type, the invention provides a passive security system that nonetheless blocks unauthorized persons and, in some configurations, even blocks authorized persons from access if their bio-data indicates they may be in physical or emotional distress. The invention can be used without facility security, but normally facility security will work in conjunction with the system in order, for example, to allow access to the facility by authorized but occasional visitors and possibly to prevent or double-check access to authorized persons. Interactions of this kind by facility security personnel are not the focus of the invention but are useful in explaining how the invention works in practice.

A security computer 14 is central to the invention. Computer 14 is used in the first instance to authorize or issue security tokens 16 to population members 10, such as students, in case facility 12 is a school. Tokens 16 can be provided in many forms. They might be smart phones, smart watches, fitness devices or any kind of bio-data sensor that may or may not be connected to a smart phone. In another aspect of the invention, the construction of the token 16 and the particular bio-data it senses is discussed below. However, the invention in main is not reliant on any particular token type.

If a population member 10 owns a viable token 16 for use in the security system of the invention, then it is presented to computer 14 which may be controlled by a manager or security officer at facility 12. Token 16 is presented to computer 14 together with some kind of identification 18 and baseline bio-data 20 for population member 10. Computer 14 authorizes at 22 token 16 by matching the identification 18 with a particular bio-data 20. Baseline bio-data 20 can either be stored on or directly accessible to computer 14 or it can be stored on token 16. Neither option is shown in FIG. 1 but that is because either option is possible within the scope of the invention.

In the event that population member 10 does not own a viable token 16 then the manager or security of facility 12 can issue a token 16 to population members 10 who provide identification 18 and bio-data 20 for association by computer 14. Even if bio-data 20 is stored on token 16 as opposed to computer 14, computer 14 is still used in the issuance or authorization 24 of tokens 16 because there must be some way to check the presented population member 10 and identification 18 are in fact permitted access to facility 12. In other words, tokens 16 should only be authorized or issued if the presenting person is a matriculated student at the school or an employed worker at the business.

Thus far we have discussed setup steps taken by population members 10, but facility 12 also requires some initial set up in order to utilize the security system of the invention. First, in addition to computer 14, facility 12 has an actuator 26 in data communication with the security computer in order to close door 28 of the facility in case the computer detects a security risk and sends a lockdown signal to the actuator. Note that door 28 is provided according to the invention as a normally-open (that is to say unlocked) door. Providing security while maintaining an unlocked door 28 is one of several objects of the invention because it reduces unwanted psychological impact on students and workers of regularly entering a locked-down facility.

Additionally, facility 12 also has one or more token readers 34. The token readers may be inside the facility and/or at one or more entrances of the facility. Facility 12 also has one or more cameras 35. The cameras may be inside the facility and/or at one or more entrances of the facility.

As population members 10 approach a camera 35, it scans their current bio-data 40. Concurrently, the reader(s) 34 may sense the locations of tokens 16 within and near the facility 12. The reader(s) 34 also may scan the stored bio-data 20 that is associated with each token 16 (stored on the token or in the computer 14 in association with the token id). The cameras and readers are in communication with the computer 14, which compares their signals. For example, the computer 14 cross-checks current bio-data 40 for each population member near a camera 35 against the locations 31 and stored bio-data 20 of each of the tokens 16. If the computer 14 detects a mismatch, then it sends the lockdown signal to the actuator 26.

At least two kinds of mismatch are contemplated. One, a mismatch of current bio-data 40 against stored bio-data 20 for a population member 10 who is carrying their token 16 at location 31, where both the camera 35 and the reader 34 detect the population member. Two, the camera 35 detects an instance of current bio-data 40 without a matching token location 31 detected by the reader 34. Either type of mismatch suggests an unauthorized population member is in or approaching the facility 12 (an “access attempt” 36). Accordingly, the lockdown signal 27 is properly broadcast from the computer 14 to the one or more actuators 26.

In another (tokenless) aspect, the computer 14 cross-checks current bio-data 40 for each population member near a camera 35 against the stored bio-data in the computer 14. If the computer detects the first type of mismatch (population member near camera does not match any stored bio-data) then it sends a lockdown signal to the one or more actuators 26.

A word about the bio-data as that term is used in this patent and for this invention. By “bio-data” is meant any physical measurement that can now or in the future be made by a camera on a person and analyzed in an attempt to identify that person with a variable degree of certainty. For example, facial scans, retinal scans, gait or posture recognition, and thermal images are types of bio-data 20 that can be measured by cameras from population members 10 and stored on or in conjunction with tokens 16 to identify persons. In like manner, one of ordinary skill in the art of bio-data identification will understand that comparing stored bio-data with currently or indeed instantaneously measured bio-data for purposes of comparison is not a binary process and instead there is a range of sameness which should be used with a concomitant range of certainty about identification from so-called “matching” of bio-data. The quantity and quality of bio-data used in an effort to match and determine identify based on prior bio-data measurements will necessarily vary the security of the system according to the invention as will be understood by one of ordinary skill.

Nonetheless, current bio-data 40 and stored bio-data 20 are analyzed for a match at 44 in computer 14. Note in this regard, stored bio-data 20 could be stored on token 16 or it could be stored in association with computer 14 and simply retrieved based on the authorization of token 16 granted at 24. Subject to the level of matching possible for the bio-data used in a system implemented according to the invention, if there is no match or an unacceptable level of certainty about a match at 44, then computer 14 generates a signal to actuator 26 to close door 28. In addition to, or in lieu of actuating door 28 closed, computer 14 could also simply notify facility security 46 that an access attempt is being made by a person of unknown identity and that they should intervene to intercept person to positively identify them —either by human intelligence or through identification 18 previously provided to computer 14 and possibly also available to security 46 for example via a mobile computing device.

Further, differences between stored bio-data 20 and current bio-data 40 may be assessed to detect whether a person carrying a token is in some kind of distress (e.g., medical, psychological). In the event distress is detected at 50, then the computer 14 may send the lockdown signal to the actuator 26 or may dispatch security 46 to assist.

As depicted in FIG. 1, a reader 34 is shown mounted in perimeter 30 near opening 32 such that it can passively scan approaching persons and tokens. The processing of all data scanned by reader 34 may take place in computer 14, but it will be understood by one of skill in the art, that reader 34 may in fact have some or all of the computing power necessary for analysis steps 38, 44 and 50. As well, reader 34 could generate the signal necessary to close door 28 via actuator 26. In some configurations, it might be useful for computer 14 to remain available for assignment of tokens, and to be situated in a location remote from reader 34 so that visitors can be issued at 22 temporary tokens/authorizations 24 remote from door 28 and so that identification analysis 18 can be performed in the same unit which issues tokens/authorizations, facilitating the distribution of necessary identification data to security 46.

Security 46 also plays another role (not shown) in a complete security system for facility 12. They need to be stationed at or near opening 32 of perimeter 30 or at some other entrance to facility 12 which is designated for use by persons who are not members of population 10. For example, in the context of a school 12, parents will need to periodically enter to meet teachers. To avoid locking door 28, these parents need to obtain temporary security tokens which can be issued by security 46, possible using computer 14 at or near opening 32. In this way, door 28 can remain normally open, and school 12 can remain inviting and not locked down while still permitting necessary persons access with appropriate precautions and without accidentally locking down facility 12.

It will be apparent to one of ordinary skill in the art, that the system described herein with reference to the figures is as an example of how to implement the disclosure and not a required or detailed production specification. A knowledgeable security professional, bio-data professional and/or programmer may elect to implement the disclosure in a different way to achieve the same benefit.

What is claimed is:

1. A system for controlling access to a facility, said system comprising:
a token carried by a facility entrant, the token storing and broadcasting the entrant's baseline bio-data;
a first sensor mounted in said facility, the first sensor detecting the current bio-data and locations of persons in the facility;
a second sensor in said facility, the second sensor detecting the location of the token;
a controller comparing the stored bio-data associated with the token to the first sensor's detected current bio-data corresponding to the token location and generating a lockdown signal in case of a mismatch; and
an actuator receiving the lockdown signal and locking a normally-open door in response to the lockdown signal.

2. The system of claim 1, wherein the stored bio-data is stored on the token.

3. The system of claim 1, wherein the stored bio-data is stored in association with a token identifier in a manner accessible by the controller.

4. The system of claim 1, wherein the stored bio-data is a facial scan.

5. The system of claim 1, wherein the stored bio-data is a retinal scan.

6. The system of claim 1, wherein the stored bio-data is a gait signature.

7. The system of claim 1, wherein the stored bio-data is a posture signature.

8. The system of claim 1, wherein the stored bio-data is a thermal image.

9. A system for controlling access to a facility, said system comprising:
a token carried by each facility entrant, each token storing and broadcasting the corresponding entrant's baseline bio-data;
a first sensor mounted in said facility, the first sensor detecting the current bio-data and locations of persons in the facility;
a second sensor in said facility, the second sensor detecting the location of each token;
a controller comparing the first sensor detections to the second sensor detections and stored bio-data, and generating a lockdown signal in case the first sensor detections do not match the second sensor detections and stored bio-data; and
an actuator receiving the lockdown signal and locking a normally-open door in response to the lockdown signal.

10. The system of claim 9, wherein the stored bio-data is stored on the token.

11. The system of claim 9, wherein the stored bio-data is stored in association with a token identifier in a manner accessible by the controller.

12. The system of claim 9, wherein the stored bio-data is a facial scan.

13. The system of claim 9, wherein the stored bio-data is a retinal scan.

14. The system of claim 9, wherein the stored bio-data is a gait signature.

15. The system of claim 9, wherein the stored bio-data is a posture signature.

16. The system of claim 9, wherein the stored bio-data is a thermal image.

17. A system for controlling access to a facility, said system comprising:
a first sensor mounted in said facility, the first sensor detecting the current bio-data and locations of persons in the facility;
a controller comparing the first sensor detections to stored bio-data, and generating a lockdown signal in case the first sensor detections do not match the stored bio-data; and
an actuator receiving the lockdown signal and locking a normally-open door in response to the lockdown signal.
